(19) United States
(12) Patent Application Publication
(10) Pub. No.: US 2022/0137315 A1
(43) Pub. Date: May 5, 2022

(54) TRACK DEVICE FOR A TELECOMMUNICATIONS PRODUCT

(71) Applicant: COMMSCOPE TECHNOLOGIES LLC, Hickory, NC (US)

(72) Inventors: Harry L. VASWANI, Garner, NC (US); Erik David BISHOP, Fuquay-Varina, NC (US)

(73) Assignee: COMMSCOPE TECHNOLOGIES LLC, Hickory, NC (US)

(21) Appl. No.: 17/435,671

(22) PCT Filed: Feb. 27, 2020
(86) PCT No.: PCT/US2020/020161

§ 371 Date: Sep. 1, 2021

Related U.S. Application Data
(60) Provisional application No. 62/812,527, filed on Mar. 1, 2019.

(51) Int. Cl. G02B 6/44; G02B 6/36

(52) U.S. Cl. CPC G02B 6/4478; G02B 6/4454; G02B 6/3616; G02B 6/4477

(57) ABSTRACT

A track device is disclosed for providing bending-radius protection and strain relief between a fiber optic cable and a telecommunications closure. The track device includes a first sidewall, and a second sidewall separated from the first sidewall by a curved channel. A secondary wall connects the first and second sidewalk, and open lateral sides are configured to receive one or more fiber optic cables for routing portions of the one or more fiber optic cables inside the curved channel.

### CROSS-REFERENCE TO RELATED APPLICATION

This application is being filed on Feb. 27, 2020 as a PCT International Patent Application and claims the benefit of U.S. Patent Application Ser. No. 62/812,527, filed on Mar. 1, 2019, the disclosure of which is incorporated herein by reference in its entirety.

### BACKGROUND

Telecommunication applications utilize fiber optic cables that often require fiber optic cable splicing and fiber optic cable storage. Telecommunications closures are often used to store spliced fiber optic cables between one or more nodes in a telecommunications network.

### SUMMARY

This disclosure relates generally to devices used in the telecommunications industry. More particularly, this disclosure relates to a track device that guides and limits the bend radius of fiber optic cables inside a telecommunications closure.

In one aspect, a track device provides bending-radius protection and strain relief between a fiber optic cable and a telecommunications closure. The track device comprises a first sidewall, a second sidewall separated from the first sidewall by a curved channel, a secondary wall connecting the first and second sidewalls, and open lateral sides configured to receive one or more fiber optic cables for routing the fiber optic cables inside the curved channel.

In another aspect, a telecommunications closure comprises a base having a plurality of slots, a cover having tabs that fit into the slots of the base and a plurality of posts, and a track device having attachment locations that receive the posts to attach the track device to the cover. The track device provides bending-radius protection and strain relief for optical fibers routed inside the telecommunications closure. The track device has a first sidewall, a second sidewall separated from the first sidewall by a curved channel, a secondary wall connecting the first and second sidewalls, and open lateral sides configured to receive one or more fiber optic cables for routing portions of the one or more fiber optic cables inside the curved channel.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### DESCRIPTION OF THE FIGURES

The following drawing figures, which form a part of this application, are illustrative of described technology and are not meant to limit the scope of the disclosure in any manner.

FIG. 1 is an exploded view of a telecommunications closure.

FIG. 2 is an isometric view of the track device installed relative to the cover, and a plurality of optical fibers from a splitter cable routed along the inside perimeter of the cover.

FIG. 3 is an isometric view of the splice tray secured to the cover.

FIG. 4 is an isometric view of the track device and splice tray relative to a base.

FIG. 5 is a detailed isometric view of the track device, splice tray, and base.

FIG. 6 is a top isometric view of the track device.

FIG. 7 is a top view of the track device.

FIG. 8 is a bottom isometric view of the track device.

FIG. 9 is a bottom view of the track device

FIG. 10 is a front view of the track device.

FIG. 11 is a rear view of the track device.

FIG. 12 is a left side view of the track device.

FIG. 13 is a right side view of the track device.

FIG. 14 illustrates a method of assembling the telecommunications closure.

FIG. 15 illustrates in more detail a step illustrated in FIG. 14.

FIG. 16 shows the track device attached to posts that project from the cover, and connectorized ends of the optical fibers plugged into the hardened connector ports of the cover.

FIG. 17 shows the splitter cable prepared to be placed inside the cover.

FIG. 18 shows a view of the splitter cable placed between a sidewall of the cover and the posts that project from the cover.

FIG. 19 shows another view of the splitter cable placed between a sidewall of the cover and the posts that project from the cover.

FIG. 20 shows the optical fibers routed through an open lateral side of the track device, and a tab being used to partially contain the optical fibers.

FIG. 21 shows the optical fibers routed through the track device.

FIG. 22 shows a view of the optical fibers being wrapped a second time along the inside perimeter of the cover.

FIG. 23 shows another view of the optical fibers being wrapped a second time along the inside perimeter of the cover.

FIG. 24 shows another view of the optical fibers being wrapped a second time along the inside perimeter of the cover.

FIG. 25 shows hooks being used to contain in proximity excess length of the optical fibers outside of the curved channel of the track device.

FIG. 26 shows an input end of the splitter cable routed through an open lateral side of the track device.

FIG. 27 shows the input end of the splitter cable routed through the curved channel of the track device.

FIG. 28 shows an MPO connector plugged into a hardened connector port.

FIG. 29 shows a ribbon cable of the MPO connector exiting the curved channel, and positioned towards a side of the cover next to the input end of the splitter cable.

FIG. 30 shows the splice tray positioned next to the cover.

FIG. 31 shows the input end and ribbon cable fed through a slot of the splice tray.

FIG. 32 shows the splice tray attached to the cover with the input end of the splitter cable and the ribbon cable of the MPO connector fed through the slot.

FIG. 33 is a detailed view of FIG. 32 that shows the posts of the cover received by the attachment locations of the splice tray.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

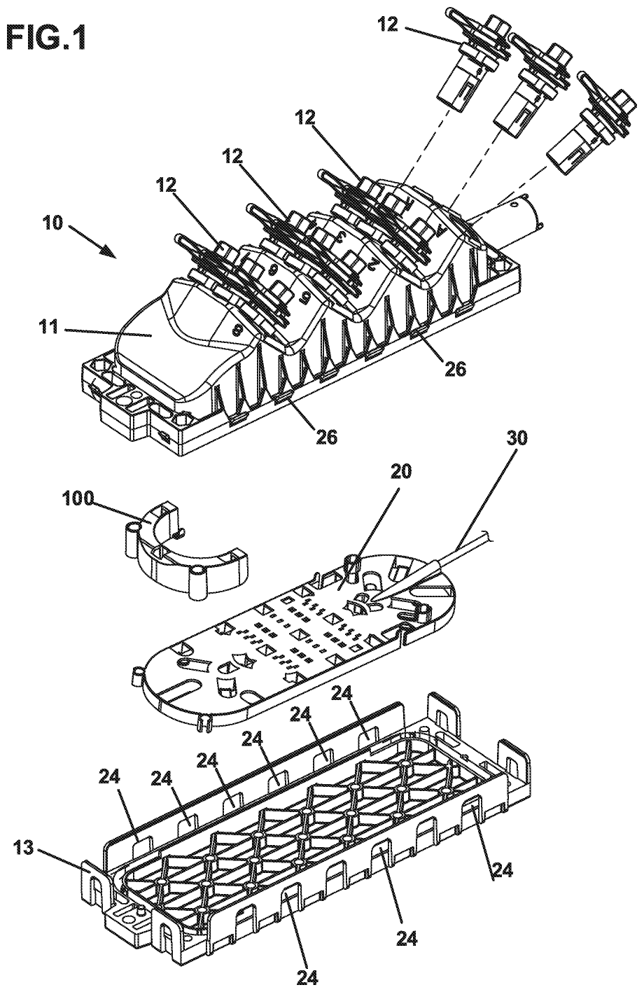

FIG. 1 is an exploded view of a telecommunications closure 10. As shown in FIG. 1, the telecommunications closure 10 includes a cover 11 that attaches to a base 13. The base 13 includes a plurality of slots 24 that each receive a corresponding tab 26 from the cover 11 to attach the base 13 to the cover 11. The cover 11 includes a plurality of hardened connector ports 12. In certain examples, the telecommunications closure 10 is a multiport service terminal (MST). In some further examples, the telecommunications closure 10 is a mini MST.

Inside the telecommunications closure 10, a track device 100 is installed onto the cover 11, and a splice tray 20 is mounted onto the track device 100 and cover 11. The telecommunications closure 10 stores a plurality of optical fibers. The track device 100 protects the optical fibers from exposure to other elements in the telecommunications closure 10, and limits the bend radius of the optical fibers when routed from one corner to the next in the closure. The splice tray 20 manages one or more optical splices.

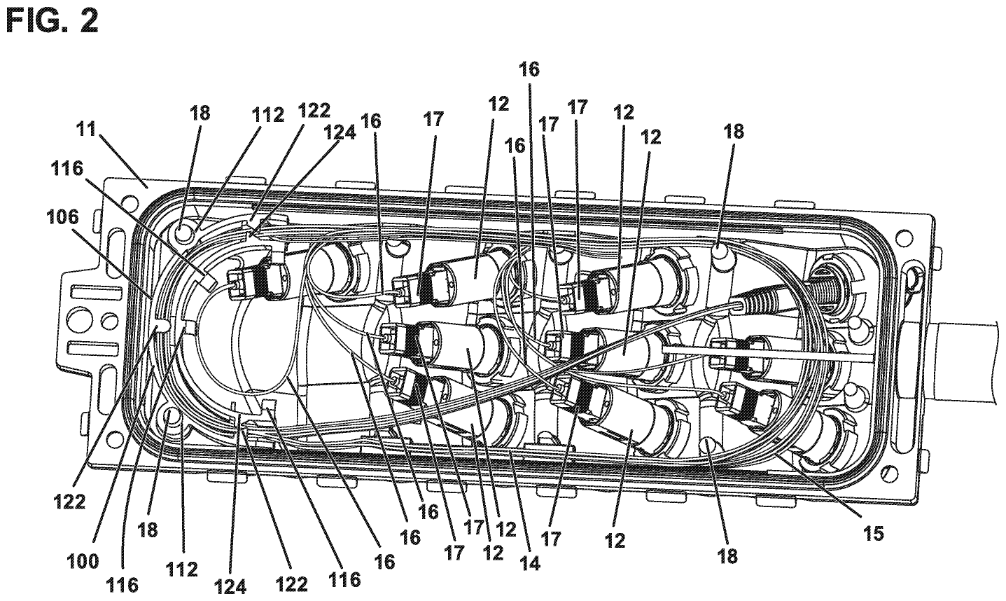

FIG. 2 is an isometric view of the track device 100 installed relative to the cover 11, and a plurality of optical fibers 16 from a splitter cable 14 routed along the inside perimeter of the cover 11. The track device 100 includes attachment locations 112. Each attachment location 112 receives a post 18 that projects from the cover 11 to secure the track device 100 inside the telecommunications closure 10. The track device 100 is secured to one end of the cover 11. In alternative examples, the track device 100 can be secured to an opposite end of the cover 11. In further examples, a track device 100 can be secured to each end of the cover 11. Accordingly, the cover 11 and track device 100 may have a variety of configurations.

The splitter cable 14 includes a pigtail 15 that breaks out into a plurality of optical fibers 16. Each optical fiber 16 is terminated by a connectorized end 17. Each connectorized end 17 can be plugged into a respective hardened connector port 12 of the cover 11.

As shown in FIG. 2, the track device 100 includes a curved channel 106 and tabs 122, 124 on a surface above the curved channel 106. The curved channel 106 limits the bend radius of the optical fibers 16 when routed along the inside perimeter of the cover 11 while the tabs 122, 124 contain the optical fibers 16 inside the curved channel 106. Advantageously, the track device 100 prevents sharp bends of the optical fibers 16 beyond a minimum radius specification when the optical fibers 16 are routed inside the telecommunications closure 10.

The track device 100 also includes hooks 116 that protrude out of the exterior edge of the curved channel 106. The hooks 116 contain in close proximity an excess length of the optical fibers 16 outside of the curved channel 106 and protect the excess length of the optical fibers 16 from being pinched by other elements inside the telecommunications closure 10.

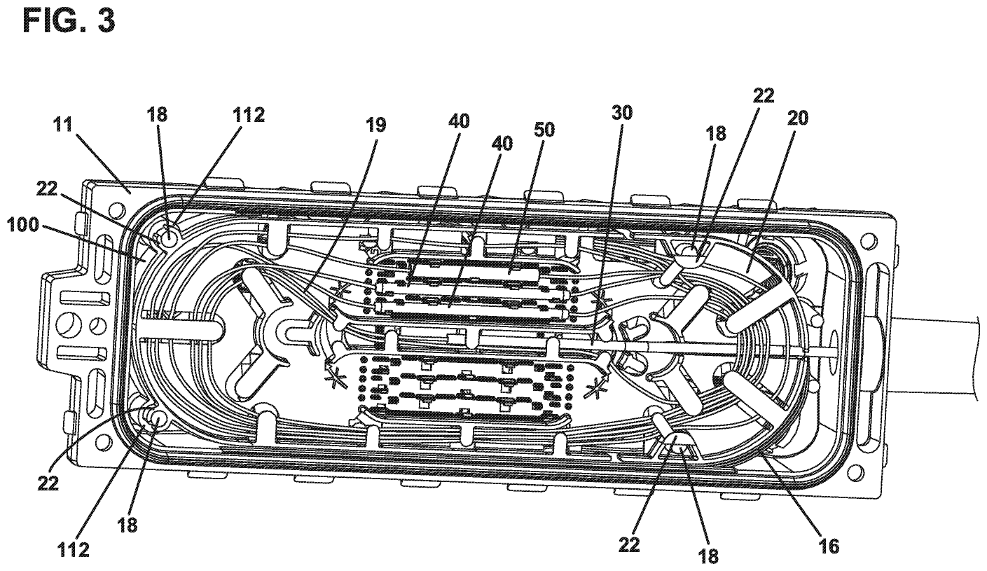

FIG. 3 is an isometric view of the splice tray 20 secured to the cover 11. As shown in FIG. 3, the splice tray 20 manages optical fibers 19 from a feeder cable 30 and provides means for holding both single splices 40 and mass fusion splices 50.

The splice tray 20 mounts over the track device 100 and is secured to the cover 11. The splice tray 20 includes attachment locations 22 that receive the posts 18 from the cover 11. At least some of the attachment locations 22 align with the attachment locations 112 of the track device 100. The attachment locations 112 of the track device 100 are configured to allow the posts 18 to extend into the attachment locations 22 on the splice tray 20. The track device 100 can provide structural support for the splice tray 20 inside the telecommunications closure 10.

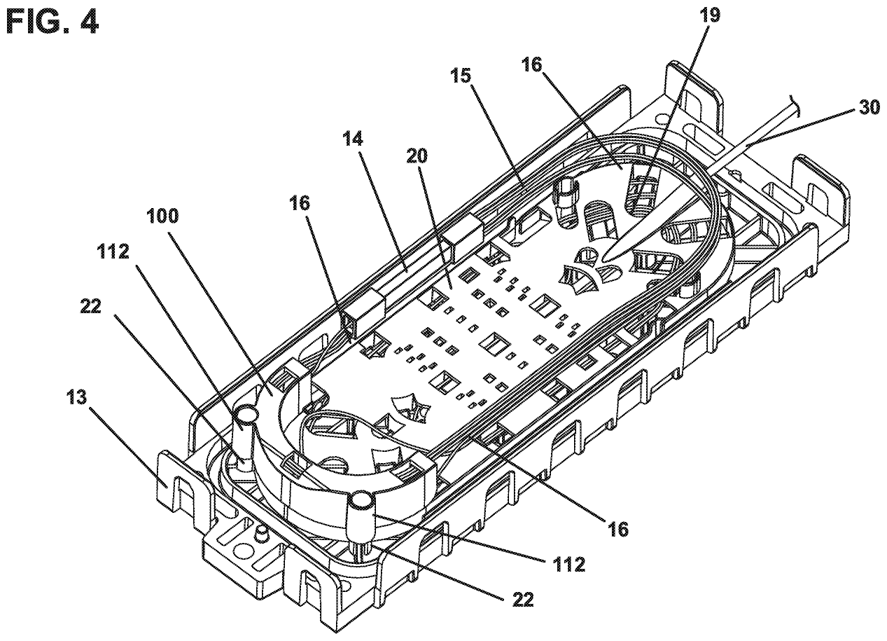

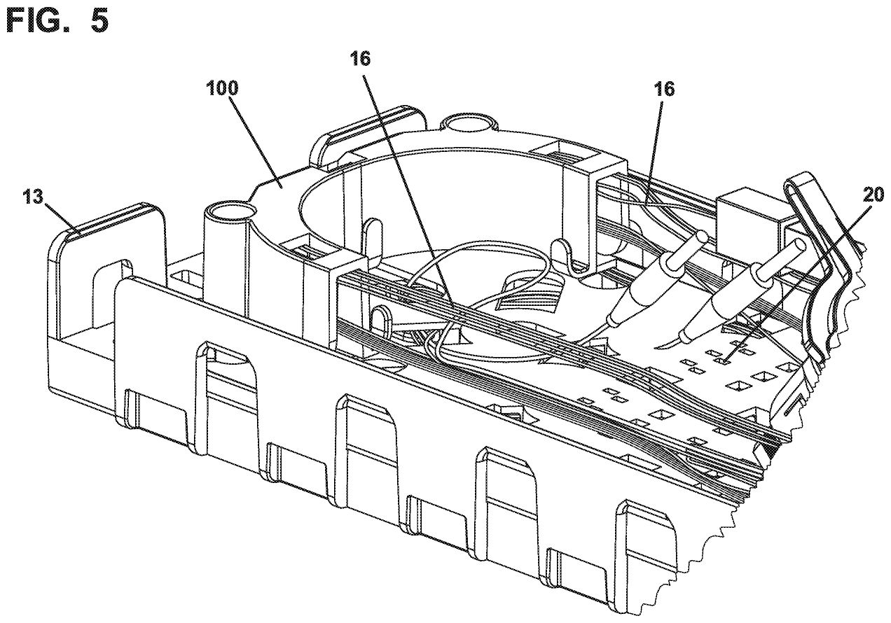

FIGS. 4 and 5 are isometric views of the track device 100 and splice tray 20 relative to the base 13. As shown in these figures, when assembled, the base 13 is installed over the splice tray 20 and track device 100, and the track device 100 is installed between the cover 11 and the splice tray 20. The splice tray 20 receives the feeder cable 30, and manages one or more splices between the feeder cable 30 and the splitter cable 14.

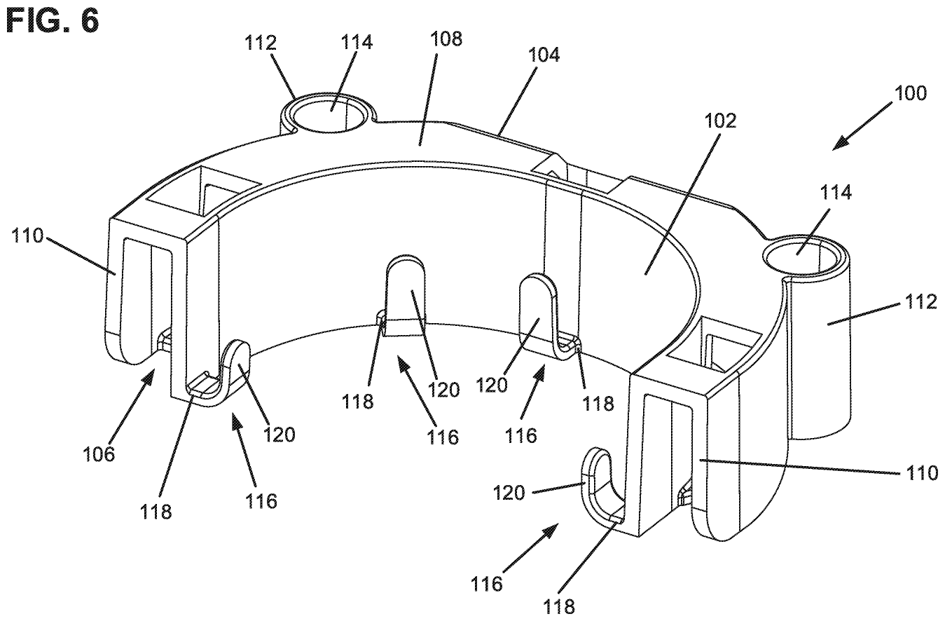

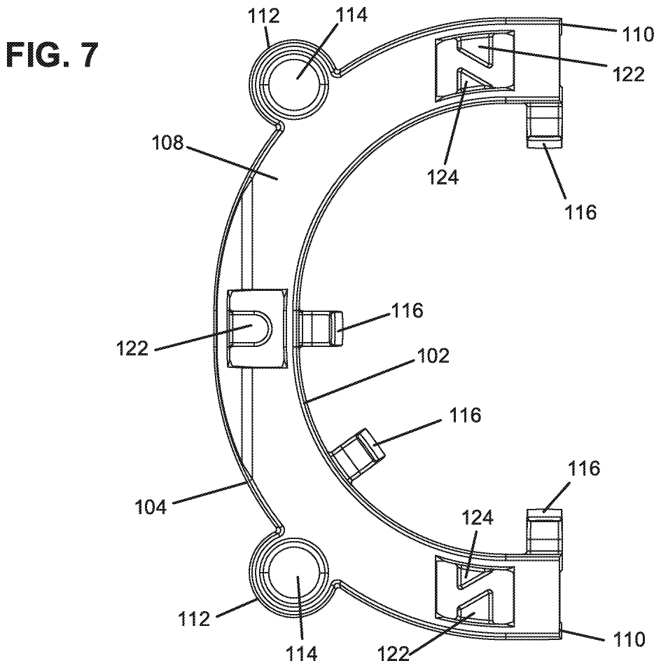

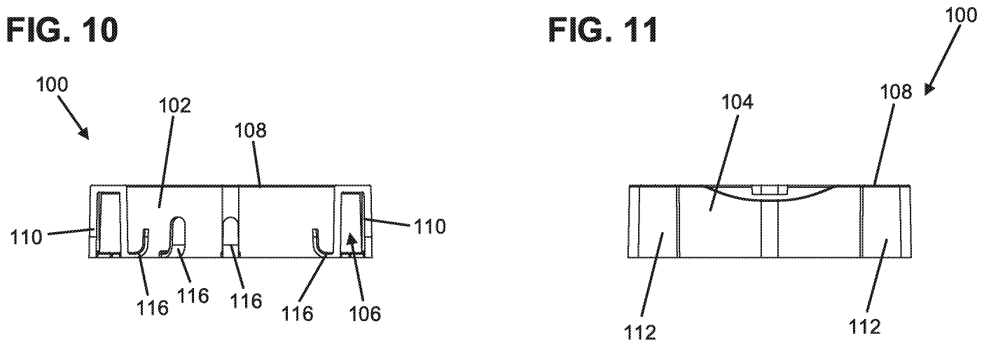

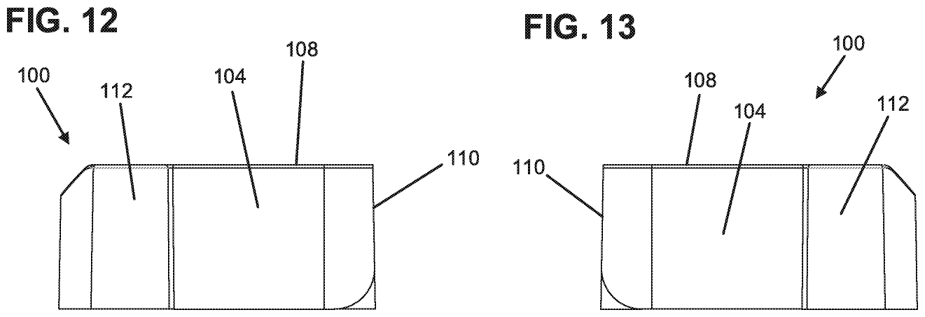

Referring to FIGS. 6-13, the track device 100 includes a first sidewall 102 and a second sidewall 104. The second sidewall 104 is separated from the first sidewall 102 by a secondary wall 108 that connects the first and second sidewalls 102, 104. The curved channel 106 is defined by the second sidewall 104, first sidewall 102, and secondary wall 108. Open lateral sides 110 are able to receive one or more of the optical fibers 16 of the splitter cable 14 for routing inside the curved channel 106. The curved channel 106 has a 180 degree bend radius defined by the second sidewall 104, first sidewall 102, and secondary wall 108.

The track device 100 includes the attachment locations 112 on the second sidewall 104. As described above, each attachment location 112 receives a post 18 to secure the track device 100 to the cover 11. Each attachment location 112 is hollow shaped and has open ends 114 for receiving the posts 18 from the cover 11. Each attachment location 112 provides a buffer in the curved channel 106 between the optical fibers 16 and the posts 18 from the cover 11. In the examples depicted in the drawings, the second sidewall 104 includes two attachment locations at opposite ends of the second sidewall 104. In addition to the examples depicted in the drawings, the attachment locations 112 may have a variety of configurations, shapes, and sizes to match a variety of configurations, shapes, and sizes for the posts 18 of the cover 11.

The track device 100 includes the hooks 116 on the first sidewall 102. Each hook 116 contains the excess length of the optical fibers 16 outside the curved channel 106, and has a first end 118 extending orthogonally from the first sidewall 102 and a second end 120 extending parallel to the first sidewall 102. The plurality of hooks 116 are positioned between the opposite ends of the first sidewall 102. Each hook 116 defines a space on an exterior surface of the first sidewall 102 to contain the one or more optical fibers 16 outside the curved channel 106.

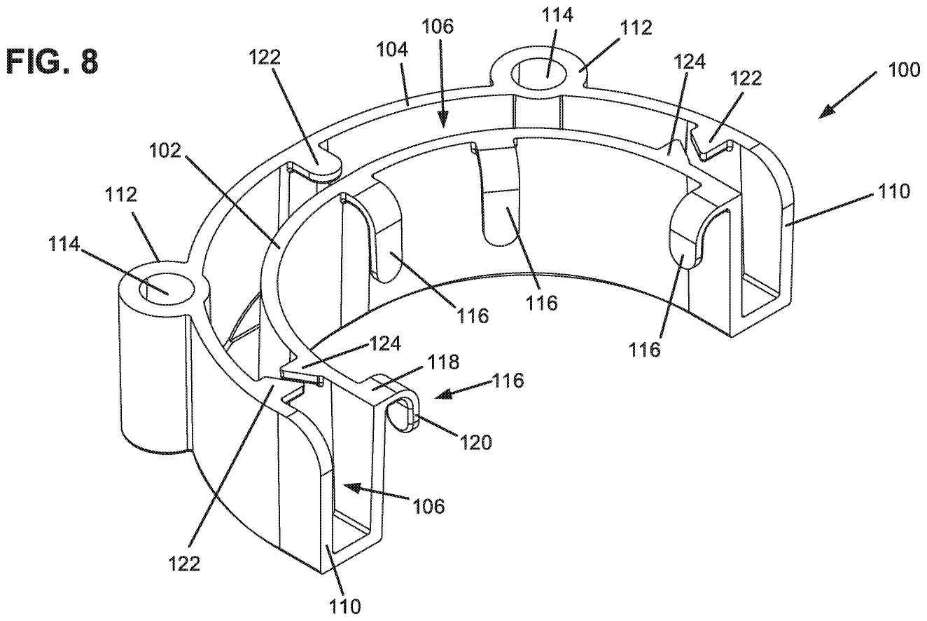

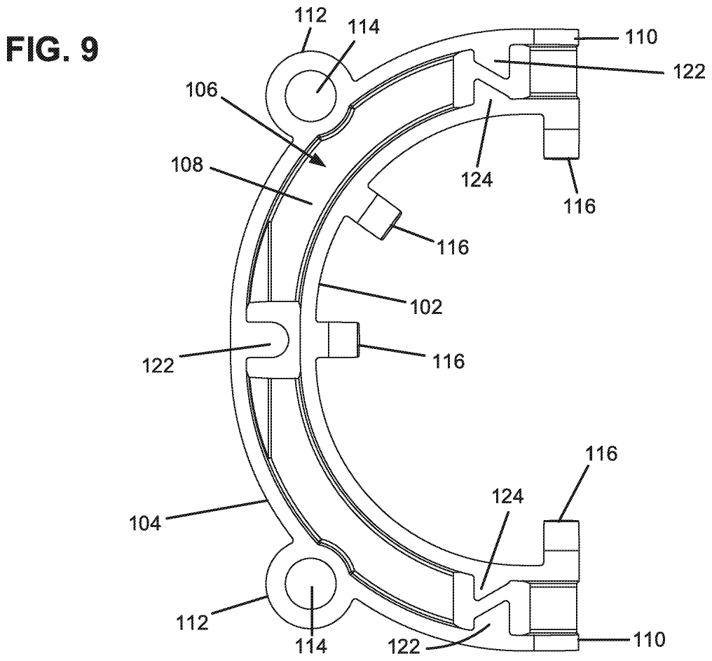

As shown in FIGS. 8 and 9, the track device 100 includes one or more tabs 122 on the second sidewall 104. Each tab 122 on the second sidewall 104 is able to contain the optical fibers 16 routed inside the curved channel 106. The track device 100 may also include one or more tabs 124 on the first sidewall 102. The one or more tabs 124 on the first sidewall 102 are configured to contain the optical fibers 16 inside the curved channel 106. In some examples, the tabs 124 on the first sidewall 102 extend adjacent to the tabs 122 on the second sidewall 104 and cooperate with the tabs 122 to contain the optical fibers 16 inside the curved channel 106.

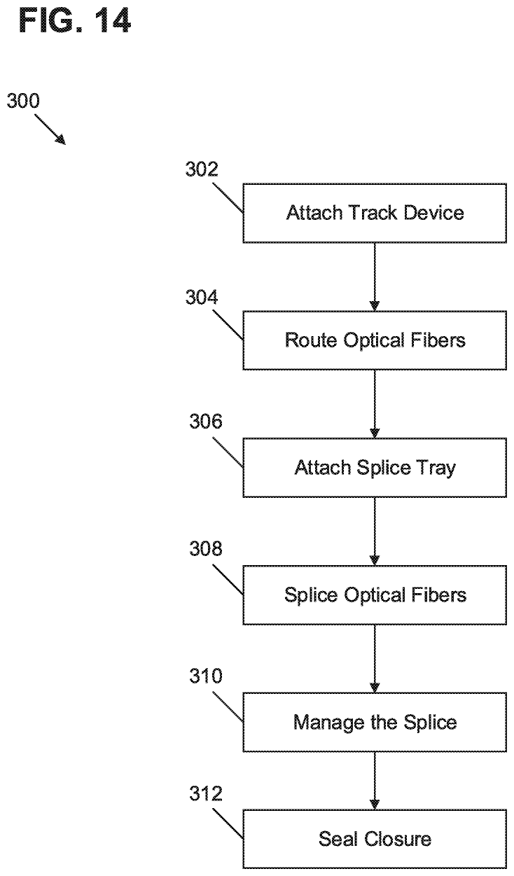

FIG. 14 illustrates a method 300 of assembling the telecommunications closure 10. As shown in FIG. 14, the method 300 includes attaching the track device 100 to the cover 11 (step 302); routing the optical fibers 16 of the splitter cable 14 through the curved channel 106 of the track device 100 (step 304); attaching the splice tray 20 to the cover 11 (step 306); splice one or more optical fibers together such as from the splitter cable 14 and the feeder cable 30 (step 308); managing the one or more splices by using the splice tray 20 (step 310); and attaching the cover 11 to the base 13 to seal the telecommunications closure 10 (step 312).

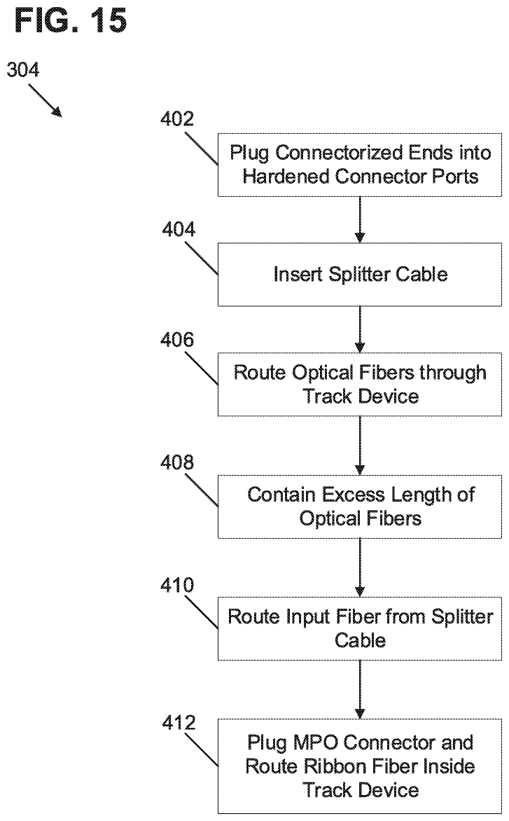

FIG. 15 illustrates in more detail the step 304 of routing the optical fibers 16. As shown in FIG. 15, routing the optical fibers 16 inside the telecommunications closure 10 includes a step 402 of plugging the connectorized ends 17 of the optical fibers 16 into the hardened connector ports 12 of the cover 11.

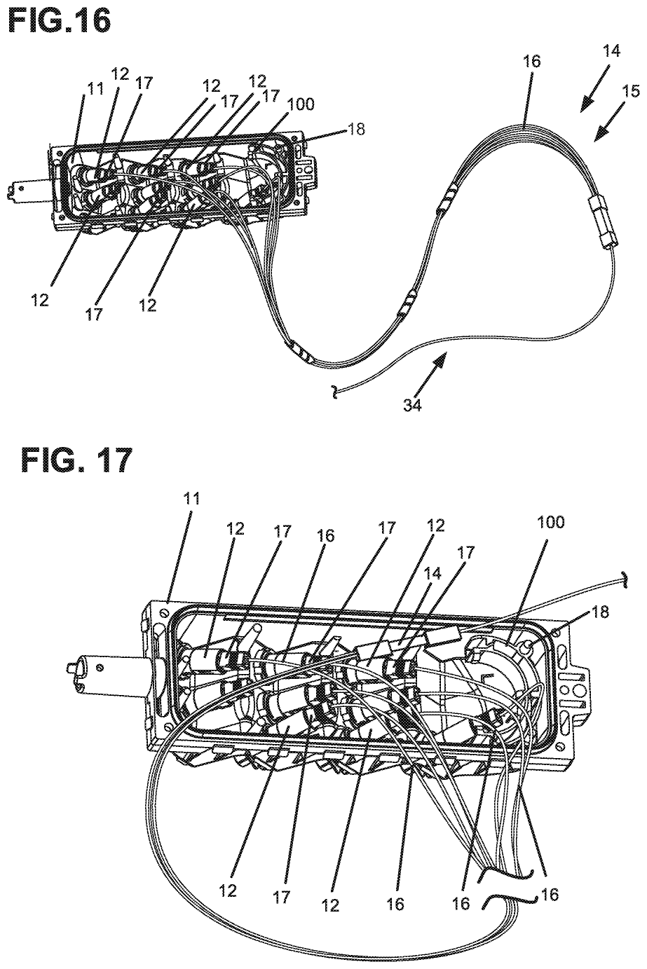

FIG. 16 shows the cover 11 after completion of step 402. As shown in FIG. 16, the track device 100 is attached to the posts 18 of the cover 11. Also, the connectorized ends 17 of the optical fibers 16 are plugged into the hardened connector ports 12 of the cover 11.

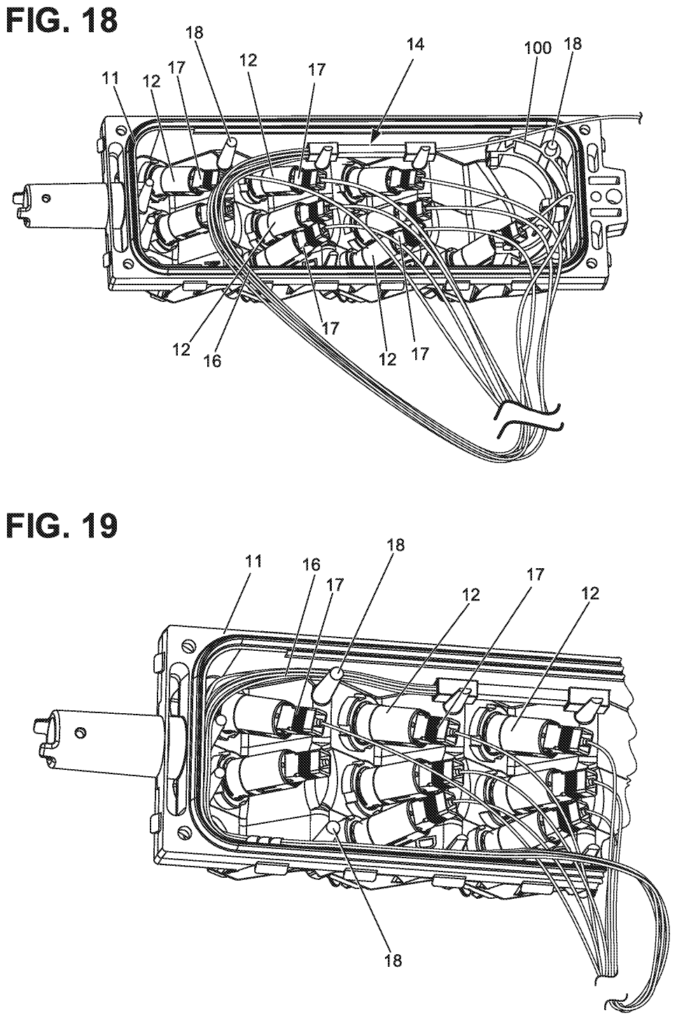

Next, routing the optical fibers 16 inside the telecommunications closure 10 includes a step 404 of inserting the splitter cable 14 inside the cover 11. FIG. 17 shows the splitter cable 14 prepared to be placed inside the cover 11. FIGS. 18 and 19 show the splitter cable 14 placed between a sidewall of the cover 11 and the posts 18 that project from the cover 11. As shown, the splitter cable 14 is pressed down to the bottom of the cover 11.

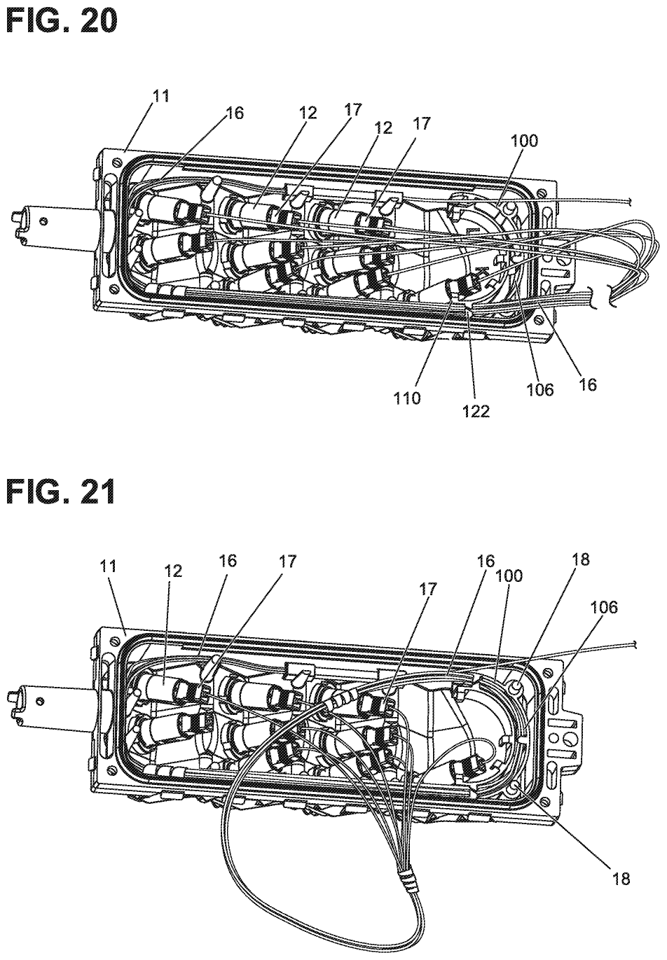

Next, routing the optical fibers 16 inside the telecommunications closure 10 includes a step 406 of routing the optical fibers 16 through the track device 100. FIG. 20 shows the optical fibers 16 routed through an open lateral side 110 of the track device 100. A tab 122 is used to partially contain the optical fibers 16 inside the curved channel 106. FIG. 21 shows the optical fibers 16 routed through the track device 100. The track device 100 provides bending-radius protection and strain relief for the optical fibers 16 along the inside perimeter of the cover 11.

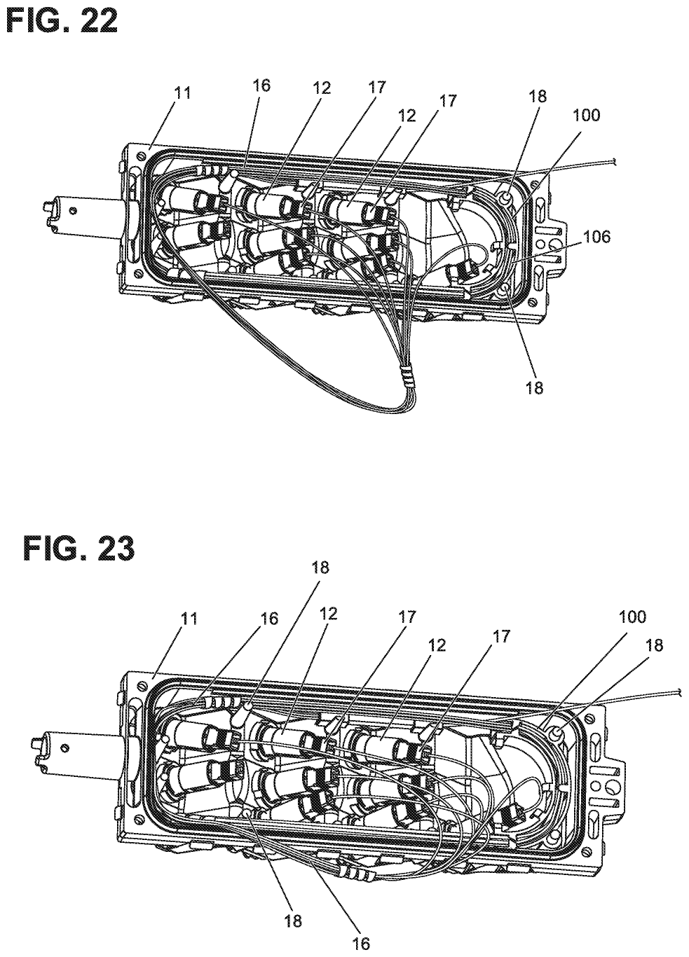

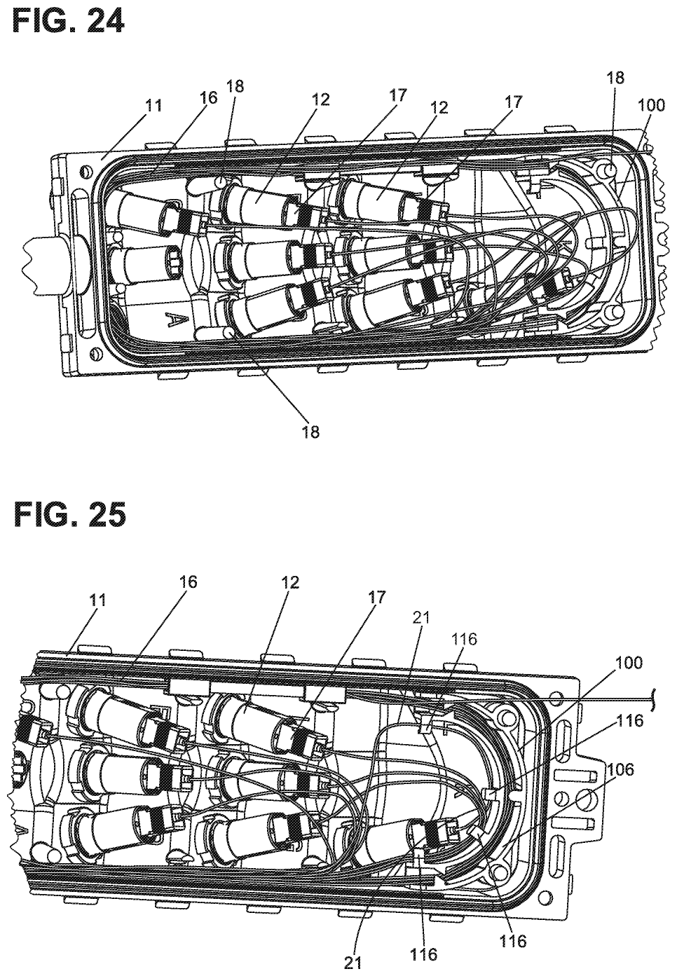

Steps 404 and 406 may be repeated as necessary so that the optical fibers 16 are wrapped multiple times along the inside perimeter of the cover 11. The optical fibers 16 can be wrapped 2, 3, or more times along the inside perimeter of the cover 11. FIGS. 22-24 show the optical fibers 16 being wrapped a second time along the inside perimeter of the cover 11.

Next, routing the optical fibers 16 inside the telecommunications closure 10 includes a step 408 of containing the excess length of the optical fibers 16 after the optical fibers 16 have been wrapped along the inside perimeter of the cover 11. FIG. 25 shows hooks 116 being used to contain the excess length 21 of the optical fibers 16 outside of the curved channel 106.

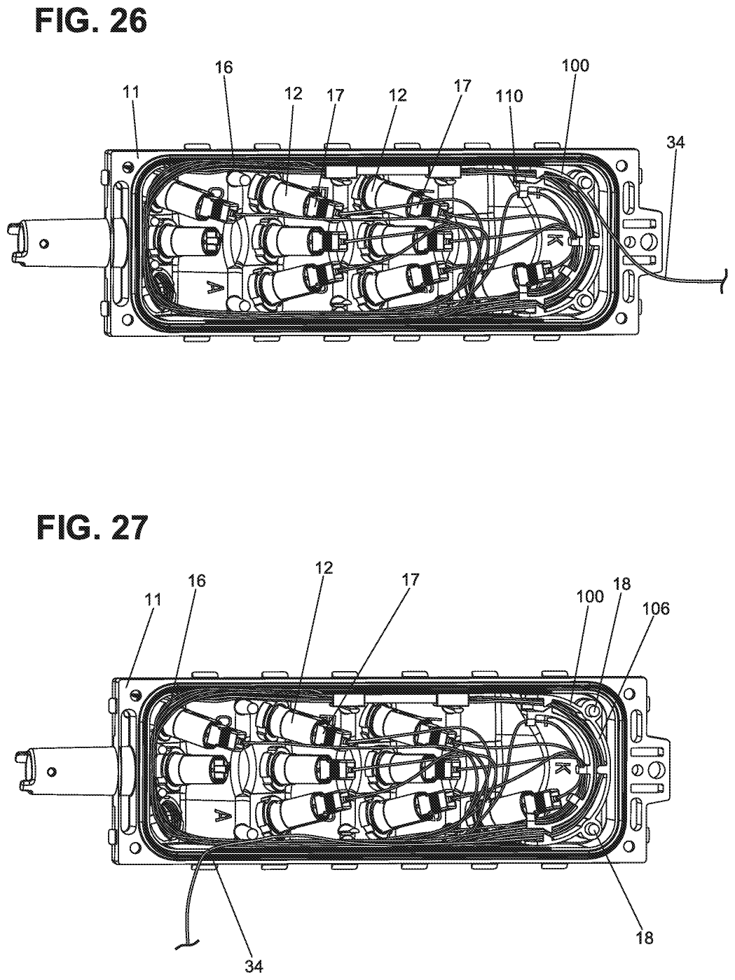

Next, step 410 includes routing an input end 34 opposite the pigtail 15 of the splitter cable 14 through the track device 100. FIG. 26 shows the input end 34 routed through an open lateral side 110 of the track device 100. FIG. 27 shows the input end 34 routed through the curved channel 106 of the track device 100, and after exiting the curved channel 106, the input end 34 is positioned towards a side of the cover 11.

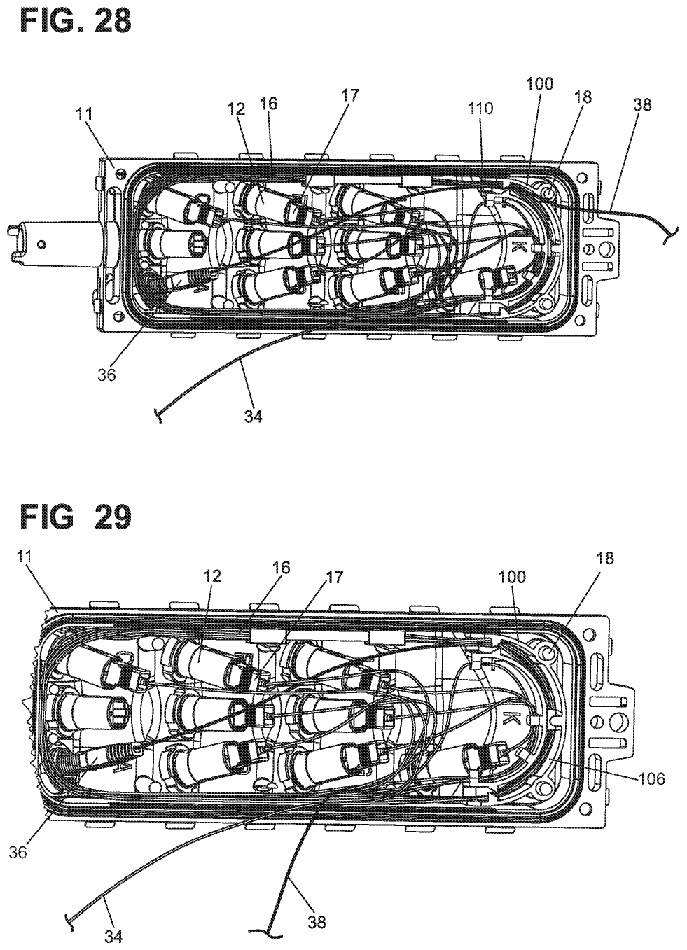

Optionally, step 412 can be performed where a Multi-fiber Push On (MPO) connector 36 is plugged into a hardened connector port 12 of the cover 11 and a ribbon cable 38 of the MPO connector 36 is routed through the curved channel 106 of the track device 100. FIG. 28 shows the MPO connector 36 plugged into a hardened connector port 12, and the ribbon cable 38 of the MPO connector 36 is routed through an open lateral side 110 of the track device 100. FIG. 29 shows the ribbon cable 38 of the MPO connector 36 exiting the curved channel 106, and positioned towards a side of the cover 11 next to the input end 34 of the splitter cable 14.

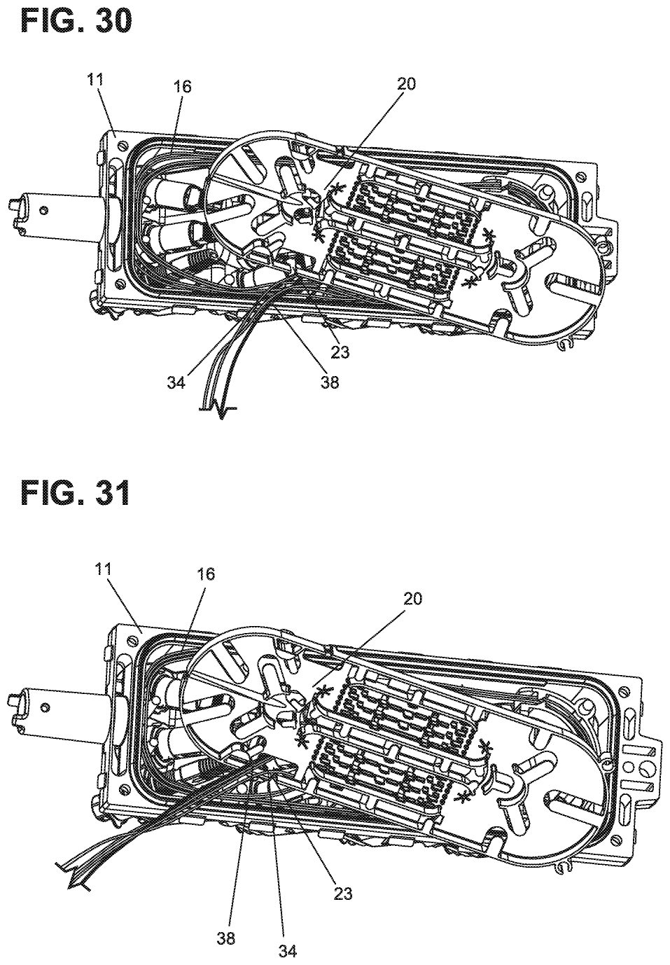

FIG. 30 shows the splice tray 20 positioned next to the cover 11 so that the input end 34 of the splitter cable 14 and the ribbon cable 38 of the MPO connector 36 are positioned next to a slot 23 of the splice tray 20. FIG. 31 shows the input end 34 and ribbon cable 38 fed through the slot 23 of the splice tray 20 before the splice tray 20 is attached to the cover 11.

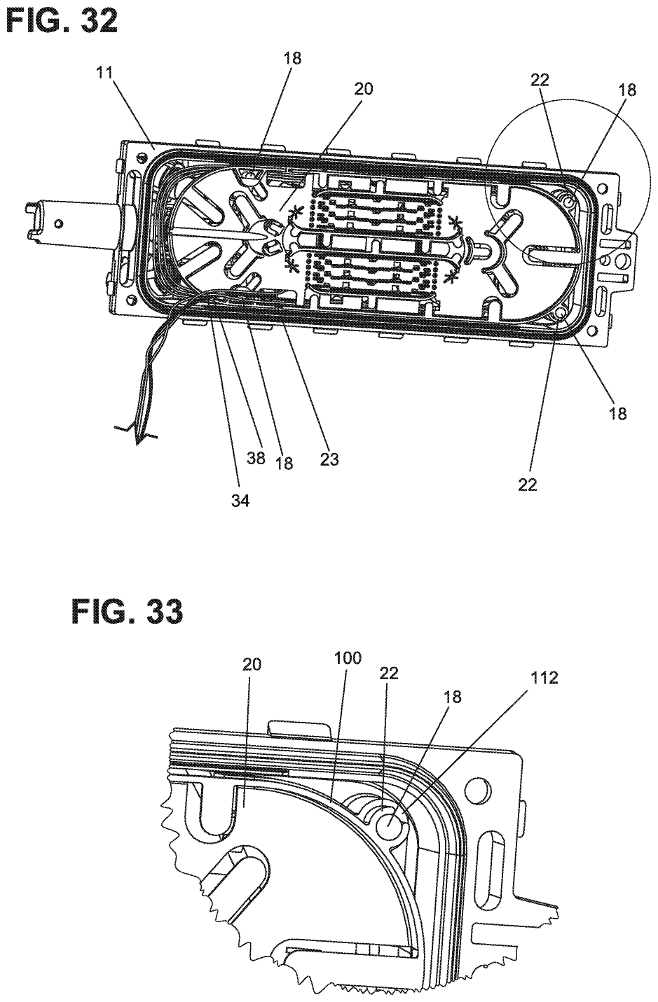

FIG. 32 shows the splice tray 20 attached to the cover 11 with the input end 34 of the splitter cable 14 and the ribbon cable 38 of the MPO connector 36 fed through the slot 23.

FIG. 33 is a detailed view of FIG. 32. As shown in FIGS. 32 and 33, the attachment locations 22 align with the attachment locations 112 of the track device 100 allowing the posts 18 of the cover 11 to be received by the attachment locations 22 of the splice tray 20. After the splice tray 20 is attached to the cover 11, the splice tray 20 can be used to manage one or more splices (step 310) such as single splices 40 and mass fusion splices 50 (see FIG. 3).

The various embodiments described above are provided by way of illustration only and should not be construed to limit the claims attached hereto. Those skilled in the art will readily recognize various modifications and changes that may be made without following the example embodiments and application illustrated and described herein, and without departing from the true spirit and scope of the following claims.

1. A track device for providing bending-radius protection and strain relief for optical fibers routed inside a telecommunications closure, the track device comprising:
a first sidewall;
a second sidewall separated from the first sidewall by a curved channel;
a secondary wall connecting the first and second sidewalls; and
open lateral sides configured to receive one or more fiber optic cables for routing the one or more fiber optic cables inside the curved channel.

2. The track device of claim 1, further comprising attachment locations on the second sidewall, each attachment location configured to receive a post from the telecommunications closure for securing the track device to the telecommunication closure.

3. The track device of claim 2, wherein each attachment location has a hollow shape open on at least one end for receiving the post.

4. The track device of claim 3, wherein each attachment location provides a buffer in the curved channel between the fiber optic cables and the posts of the telecommunications closure.

5. The track device of claim 4, wherein the second sidewall includes two attachment locations towards opposite ends of the second sidewall.

6. The track device of claim 1, further comprising hooks on the first sidewall, each hook configured to contain one or more fiber optic cables outside the curved channel.

7. The track device of claim 6, wherein each hook has a first end extending orthogonally from the first sidewall and a second end extending parallel to the first sidewall.

8. The track device of claim 7, wherein each hook defines a space on an exterior surface of the first sidewall to contain the one or more fiber optic cables outside the curved channel.

9. The track device of claim 8, wherein the plurality of hooks are positioned between opposite ends of the first sidewall.

10. The track device of claim 1, further comprising one or more tabs on the second sidewall, each tab configured to contain one or more fiber optic cables inside the curved channel.

11. The track device of claim 10, further comprising one or more tabs on the first sidewall, each tab configured to contain one or more fiber optic cables inside the curved channel.

12. The track device of claim 1, wherein the track device is configured for installation between the telecommunications closure and a splice tray.

13. The track device of claim 12, wherein the track device is configured to provide structural support for a first end of the splice tray inside the telecommunications closure.

14. The track device of claim 13, wherein the second sidewall includes attachment locations that align with corresponding attachment locations on the first end of the splice tray, and wherein each attachment location is configured to receive a post from the telecommunications closure for securing the track device and the splice tray to the telecommunication closure.

15. The track device of claim 14, wherein the track device is configured for installation inside a multiport service terminal having a plurality of hardened plug-and-play connector ports.

16. A telecommunications closure comprising:
a base;
a cover attached to the base, the cover having a plurality of posts; and
a track device having attachment locations that receive the posts from the cover to attach the track device to the cover, the track device providing bending-radius protection and strain relief for optical fibers routed inside the telecommunications closure, the track device having:
a first sidewall;
a second sidewall separated from the first sidewall by a curved channel;
a secondary wall connecting the first and second sidewalls; and
open lateral sides configured to receive one or more fiber optic cables for routing portions of the one or more fiber optic cables inside the curved channel.

17. The telecommunications closure of claim 16, further comprising splice tray mounted over the track device, the splice tray configured to manage one or more optical splices.

18. The telecommunications closure of claim 17, wherein the attachment locations of the track device align with attachment locations on the splice tray and are configured to allow the posts to extend into the attachment locations on the splice tray.

19. The telecommunications closure of claim 18, further comprising a plurality of optical fibers routed inside the telecommunications closure, at least a portion of the plurality of optical fibers routed through the curved channel of the track device.

20. The telecommunications closure of claim 19, wherein the track device further includes a plurality of hooks on the first sidewall, and wherein at least a portion of the plurality of optical fibers is held in a space on an exterior surface of the first sidewall defined by the hooks.

21. The telecommunications closure of claim 20, wherein the cover includes a plurality of hardened connector ports.

22. The telecommunications closure of claim 21, wherein the telecommunications closure is a multiport service terminal.
